(19) United States
(12) Patent Application Publication
(10) Pub. No.: US 2013/0118878 A1
(43) Pub. Date: May 16, 2013

(54) Input Assembly For A Waterproof Keyboard

(71) Applicant: Dale Purcocks, Chepstow Gwent (GB)

(72) Inventor: Dale Purcocks, Chepstow Gwent (GB)

(21) Appl. No.: 13/811,892

(22) PCT Filed: Jul. 25, 2011
(86) PCT No.: PCT/EP2011/062747

§ 371 Date: Jan. 28, 2013

(30) Foreign Application Priority Data
Jul. 23, 2010 (GB) 1012374.3
Mar. 22, 2011 (GB) 1104816.2

(51) Int. Cl. H01H 9/04; H01H 11/00

(52) U.S. Cl. CPC H01H 9/04; H01H 11/00
USPC 200/5 A; 200/302.1; 29/622

(57) ABSTRACT

An input assembly for a human interface device such as a keyboard comprises a first membrane (20) and second membrane (22) each having an electrical circuit provided on a surface thereof. The first and second (20)(22) membranes are arranged such that the electrical circuits of each membrane are facing each other. Means (24) is provided for permitting selective electrical connection between the electrical circuits of the first and second membranes (20)(22). An electrical connector (42) is connected to the electrical circuit of one or both of the first or second membranes (20)(22) and comprises a connection portion configured for connection to a further electrical component. Sealing means is provided which is configured to seal the membrane assembly to a further surface to form a sealed unit which seals and encapsulates both the electrical circuits of the membrane assembly and the connection portion of the electrical connector (42).

The present invention relates to an input assembly for a human interface device and in particular to a waterproof input assembly for a keyboard.

Keyboards provide an interface between a computer and a user, with the user providing input commands to the computer via the keyboard. A computer keyboard essentially comprises a series of switches connected to a microprocessor that monitors the state of each switch and initiates a specific response to a change in that state.

Typically, the switch circuitry is provided by an input circuit unit formed from a sandwich of membranes, with upper and lower membranes having printed circuits on their facing surfaces, spaced by a further membrane which allows contact between the upper and lower circuits when the upper membrane is engaged by one of the keyboard keys.

The ability of keyboards to be impervious to liquids entering or contacting the keyboard is becoming increasingly important as the use of externally located keyboards for use in applications such as information kiosks or public internet access points increases. In addition, there is a need in environments such as hospitals for keyboards to be washable to enable them to be frequently sterilized. A waterproof keyboard is also extremely desirable in laptop applications, where liquid spilt onto the keyboard can not only damage the keyboard, but also the internal circuitry of the laptop causing serious damage.

In an attempt to provide a waterproof dome switch keyboard, several arrangements have been proposed. For example, in the arrangement described in U.S. Pat. No. 6,542,355 the input circuit unit is sandwiched are sealed between an elastomeric sheet and a further base membrane. Such an arrangement requires additional components and additional assembly steps, thereby increasing manufacturing time and cost. In addition, positioning an elastomeric sheet between the keys and the input circuit unit impedes the ability of the keys to contact the input circuit unit and delays contact time.

In other arrangements the upper and lower membranes are sealed around their periphery to form a sealed input circuit unit. However, the electrical contacts for connection of the input circuit unit to external components, and the components themselves must also be waterproofed, requiring for example further waterproof component casings. This again increases the number of components and assembly complexity, as well as increasing the bulk volume of the keyboard components.

It is therefore desirable to provide an improved input assembly for a keyboard which addresses the above described problems and/or which offers improvements generally.

According to the present invention there is provided an input assembly for a keyboard as described in the accompanying claims. In addition, there is also provided in accordance with the present invention a method of forming an input assembly as described in the accompanying claims.

In an embodiment of the invention there is provided an input assembly for a human interface device such as a keyboard; the input assembly comprising a membrane assembly including a first membrane having an electrical circuit provided on a surface thereof, a second membrane having electrical circuit provided on a surface thereof, the first and second membranes being arranged such that the electrical circuits of each membrane are facing each other, and means for permitting selective electrical connection between the electrical circuits of the first and second membranes. An electrical connector is connected to the electrical circuit of one or both of the first or second membranes and comprises a connection portion configured for connection to a further electrical component. Sealing means is provided which is configured to seal the membrane assembly to a further surface to form a sealed unit which seals and encapsulates both the electrical circuits of the membrane assembly and the connection portion of the electrical connector.

This arrangement enables a completely waterproof keyboard assembly to be achieved by utilising the input membrane assembly to seal the both the keyboard input circuitry, and any additional electrical components such as a pcb to which the input circuitry is connected. The membrane assembly, when connected to the support surface, forms a completely sealed unit, which is able to contain the keyboard circuitry, pcb, and any other electrical componentry. This sealed unit is able to be easily installed into a keyboard ‘shell’ comprising a keytop and base, although the support surface may itself form the base. As the keytop comprises only mechanical parts (i.e the moving keys), this part of the assembly can be an open and unsealed, allowing it to be rinsed with water or otherwise washed and sanitized during use.

Sealing the membrane assembly to a further surface, and arranging the electrical connections and additional component in such a way that they are contained and sealed beneath the membrane assembly member to seal the additional components simplifies construction of the keyboard by minimizing the number of parts, and in particular by obviating the requirement for additional sealing means to seal the additional components. Providing an independent, sealed input unit is also advantageous as the sealed unit may be manufactured independently of the remaining keyboard components, and thereby defines a universal sealed input assembly which may be combined with a wide range of varying keyboard structures and configurations.

The sealing means may define a sealing perimeter and the connection portion of the electrical connector is arranged such that it is located within the sealing perimeter to be sealed and encapsulated by the sealing means when the sealing means is sealed to the further surface. Locating the connection portion within the sealing perimeter ensures full sealing of the connection portion, and hence any component to which it is connected, by the membrane assembly. This is in contrast to arrangements of the prior art in which the electrical connections from membrane assembly extend externally of the membrane periphery for external connection to a component such as a pcb. This further component then requires additional sealing means and further storage space within the keyboard assembly extending outside the footprint of the membrane assembly.

The input assembly may further comprising a support member defining the further surface, wherein the support member comprises a recess configured to receive the further electrical component connected to the electrical connector, the recess being arranged such that when the membrane assembly is sealed to the support member the recess is located within the sealing perimeter such that the sealing means seals the recess and any further electrical component contained therein. The recess defines a ‘coffin’ for holding the further electrical component in a sunken location, below the upper surface of the support member to which the membrane assembly is sealed. The inner surface of the recess is contiguous with the upper surface of the support member. The recess may be configured and arranged such that when the further electrical component connected to the electrical connector is received within the recess the membrane assembly is able to lie substantially flush with the surface of support member and seal thereto.

The recess enables the further component to be positioned within the peripheral boundaries of the membrane assembly such that it is sealed thereby, while also ensuring that the membrane assembly is able to lie flush with the support surface. This is important as the membrane assembly must be able to lie in a flush, uninterrupted plane to enable the keyboard keys located above to suitably engage and interact with the input assembly in a consistent and accurate manner Preferably the recess is positioned such that it is within the sealing periphery, by outside the boundary defined by the electrical circuits, thereby ensuring that an uninterrupted support surface is present beneath the electrical circuits to support the engagement from the keys above. Alternatively, or in addition, a recess may be located within the boundary of the electrical circuit and provided with a roof or cover.

In this way, it is the use of the recess which permits the connection portion of the electrical connector to be located within and sealed beneath the membrane assembly. In the arrangements of the prior art this has not been possible, or indeed contemplated. Instead, it has always been essential the electrical connector extends outwardly of the membrane assembly for onward connection to a further electrical component, and inward connection would require the component to be located beneath the membrane assembly which previously would have prevented the assembly from lying flat and from sealing to the support surface.

The support member is preferably an elongate planar member. The support member may be the base of a keyboard assembly, or may be a separate member configured to be mounted to the base of such a keyboard assembly.

The recess may comprise a port configured to receive an additional electrical connector for connecting to the further electrical component. The recess is defined in the upper surface of the support member, and the port extends through the support member to the lower surface thereof to permit connection to external components, the port comprising a seal to prevent liquid egress into the recess. In this way, an electrical component which requires external electrical connection may be buried and sealed beneath the membrane assembly, with the required external connection being achieved through the port, which may be effectively sealed to prevent liquid from entering the sealed unit through the recess. The external connection may link for example to a card reader located beneath the keyboard base, or may be a usb connection. The port may also be internally directed, and may connect to an additional component located in a further recess formed in the support member.

The support member may comprises one or more additional recesses configured to receive electrical components, each of the recesses being arranged such that when the membrane assembly is secured to the support member the recess is located within the sealing perimeter to be sealed by the sealing means. Two or more of the recesses may be interconnected by channels or other such conduits to enable electrical connection between the components received with the recesses. As such, all electrical components required for a particular keyboard may be sealed and contained beneath the membrane assembly in the provided recesses in a compact and watertight manner.

The assembly membrane and the support member form a sealed unit, with the electrical circuits and further electrical component being contained and sealed therein.

The electrical connector is a conductive track formed as part the printed electrical circuit of the first or second membrane, and the connection portion is located inboard of the peripheral edge of the membrane to which the connector corresponds. Preferably, the conductive track connector extends inwardly of the boundary defined by the electrical circuits. This is in contrast to the arrangements of the prior art

The electrical connector may be configured such that the connection portion is orientable downwardly relative the membrane to which it is connected for connection to the further electrical component. The second membrane is preferably a lower membrane configured to be located between the first membrane and the further surface when the membrane assembly is sealed thereto, and the electrical connector is an integral part of the electrical circuit of the second membrane. The connection track is preferably bendable downwardly to permit it to connect to a pcb or other such component.

The input assembly may further comprise a spacer member provided between the first and second membranes which defines the means configured to permit selective electrical connection between the electrical circuits of the first and second membranes. The spacer member is a membrane having apertures located at specific points corresponding to connection nodes between the upper and lower apertures, the thickness of the spacer member and the size of the apertures being selected to hold the upper and lower membranes apart until the upper membrane is engaged from above a depressed key.

The spacer member may comprise a window formed therein which is arranged to correspond to the location of the electrical connector such that it is alignable over the electrical connector when the spacer membrane is secured to the second membrane to permit access thereto during assembly. Where the connection tab is extended downwards for insertion into the connection slot of a pcb, the window allows the assembler to adhere the second membrane and spacer membrane to the base, and then subsequently access the connection tab for connection to the pcb.

The sealing means may comprise a surface of the membrane assembly which defines a sealing surface and is adhered to the further surface. The sealing surface may be the lower surface of the second membrane, and is preferably positioned at the peripheral edge thereof.

At least part of the peripheral edge of the first membrane or spacer member may extend past at least part of the peripheral edge of the second membrane to define the sealing surface. Alternatively, a further membrane may be secured over the first and second membranes to form the sealing member.

The sealing surface may extends around the entire periphery of the first membrane or spacer membrane.

At least a portion of the first membrane may define the sealing surface with at least part of the peripheral edge of the first membrane extending past the peripheral edge of the spacer member and second membrane to seal the lower membrane and the spacer member between the first surface and the further surface.

In another aspect of the invention there is provided a method of forming an input assembly for a human interface device such as a keyboard, the method comprising providing a membrane assembly including a first membrane having an electrical circuit provided on a surface thereof, a second membrane having electrical circuit provided on a surface thereof, the first and second membranes being arranged such that the electrical circuits of each membrane are facing each other, and means for permitting selective electrical connection between the electrical circuits of the first and second membranes; connecting a connection portion of an electrical connector connected to the electrical circuit of one or both of the first or second membranes and comprising configured to a further electrical component; sealing the membrane assembly to the further surface such that the means for sealing means defines a sealing perimeter which surrounds and seals both the connection portion of the electrical connector and the further electrical component to which it is connected.

The method may further comprise the step of locating the further electrical component in a recess in a support member defining the further surface prior to sealing the membrane assembly to the further surface, such that the membrane assembly seals the component within the recess when sealed to the further surface.

In a yet further aspect of the invention there is provided a keyboard assembly comprising an input assembly as described above, and a key pad including a plurality of keys in operable communication with the electrical circuits of the membrane assembly.

In another aspect of the invention there is provided an input assembly for a human interface device such as a keyboard; the input assembly comprising a first membrane having an electrical circuit provided on a surface thereof; a second membrane having electrical circuit provided on a surface thereof, the first and second membranes being arranged such that the electrical circuits of each membrane are facing each other; and a spacer member provided between the first and second membranes configured to permit selective electrical connection between the electrical circuits of the first and second membranes. At least a portion of the first membrane or at least a portion of the spacer member defines a sealing surface for sealing the lower membrane between the first surface or spacer member and a further surface.

In this way, the first membrane defines a sealing blanket for sealing and encapsulating the circuitry of the first and second membranes, and the electrical connections thereof, as well as any components connected thereto, against a further surface which may be the keyboard base or a further support plate. As such, no additional sealing member is required, and the first membrane provides the dual function of carrying the keyboard circuitry and forming a sealing blanket, thereby reducing component numbers, simplifying the input assembly and its manufacture, and reducing costs.

At least part of the peripheral edge of the first membrane or spacer member may extend past at least part of the peripheral edge of the second membrane to define the sealing surface. As such, the sealing surface is defined by a peripheral overhanging portion of the first membrane.

The sealing surface may extend around the entire periphery of the first membrane or spacer membrane.

At least a portion of the first membrane may define the sealing surface and at least part of the peripheral edge of the first membrane extends past the peripheral edge of the spacer member and second membrane to seal the lower membrane and the spacer member between the first surface and a further surface.

At least a portion of the spacer member may define the sealing surface and at least part of the peripheral edge of the spacer member extends past the peripheral edge of the second membrane to seal the lower membrane between the spacer member and a further surface.

The second membrane may comprise a first electrical connector for connection to a further electrical component and the sealing surface is arranged outwardly of the connector such that the connector is sealed when the sealing surface is sealed to the further surface.

The second membrane may comprise a second membrane comprises a second electrical connector for connection to a further electrical component, the second electrical connector being electrically connected to the electrical circuit of the upper membrane, the upper membrane being configured such that the sealing surface is located outwards of the second connector to seal the second connector when the sealing surface is sealed to the further surface.

The second membrane comprises a pair of tabs extending from its peripheral edge, the tabs being provided with the electrical connector and second electrical connector and located inwards of the sealing surface.

The input assembly may further comprise a support member defining the further surface. The support member may be arranged on the opposing side of the second membrane to the spacer member and wherein the sealing surface is secured to the support member to encapsulate and seal the second membrane.

The support member may be a rigid support plate, such as a steel plate. The steel plate may include slots or apertures formed therein to permit connection to the first and/or second membranes by components positioned beneath the plate.

The peripheral edge of the support member may correspond in shape to the peripheral edge of the first membrane such that the peripheral edges align when the sealing surface is sealed to the support member to form a laminate assembly sealed around its periphery.

The support member may comprise a sealing portion configured to align with and seal against the sealing surface and a receiving section for receiving a further component, the receiving section being located inwards of the sealing portion such that the receiving section is sealed beneath the first membrane when the sealing surface and sealing portion are sealed together.

The spacer membrane may be formed from an electroluminescent material, the input assembly further comprising electrical supply means configured for supplying an electrical current to the spacer membrane.

In another aspect of the invention there is provided a method of forming an input assembly for a human interface device such as a keyboard, the method comprising providing a first membrane having an electrical circuit provided on a surface thereof; providing a second membrane having electrical circuit provided on a surface thereof; arranging the first and second membranes such that the electrical circuits of each membrane are facing each other; providing a spacer member between the first and second membranes configured to permit selective electrical connection between the electrical circuits of the first and second membranes; securing a sealing surface defined by at least a portion of the first membrane or at least a portion of the spacer member to a further surface to seal the lower membrane between the first surface or spacer member and the further surface.

In a yet further aspect of the invention there is provided an input assembly for a human interface device such as a keyboard; the input assembly comprising a first membrane having an electrical circuit provided on a surface thereof; a second membrane having electrical circuit provided on a surface thereof, the first and second membranes being arranged such that the electrical circuits of each membrane are facing each other; and a spacer member provided between the first and second membranes configured to permit selective electrical connection between the electrical circuits of the first and second membranes. At least a portion of the spacer membrane is formed from an electroluminescent material.

In this way, the spacer membrane is a dual function component providing selective electrical isolation between the first and second membranes, as well as providing illumination for the keyboard. The requirement for a separate electroluminescent sheet is therefore obviated. In addition, the spacer member and hence the electroluminescent sheet, is able to be sealed and encapsulated by the first membrane, rather than requiring separate sealing means.

The input assembly may further comprise electrical supply means configured for supplying an electrical current to the spacer membrane.

The present invention will now be described by way of example only with reference to the following illustrative figures in which:

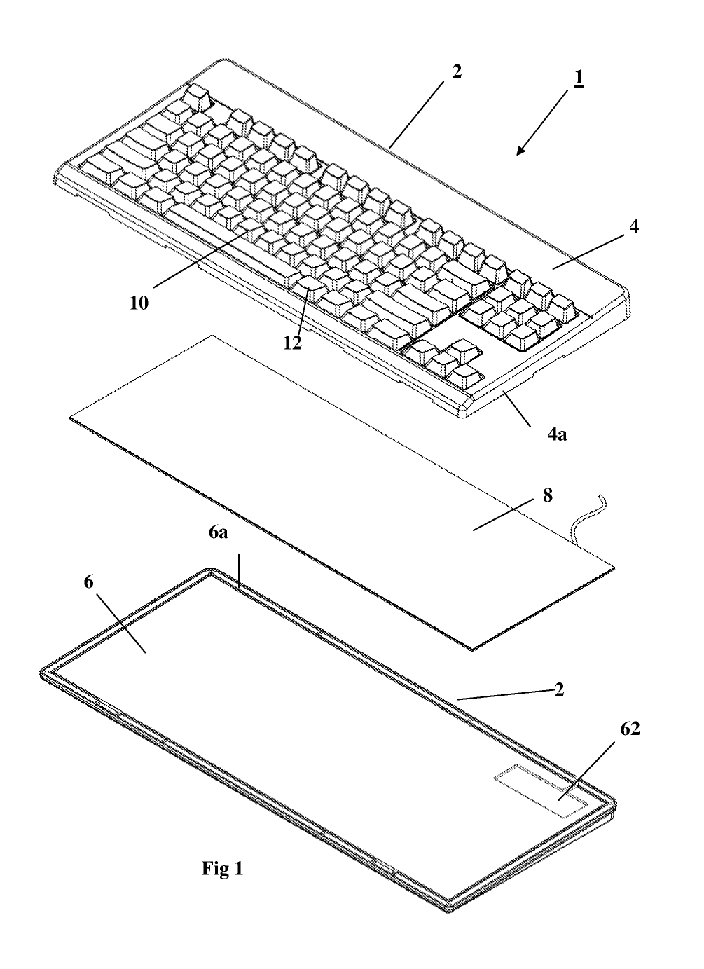

FIG. 1 shows an exploded view of a keyboard including an input assembly according to an embodiment of the invention;

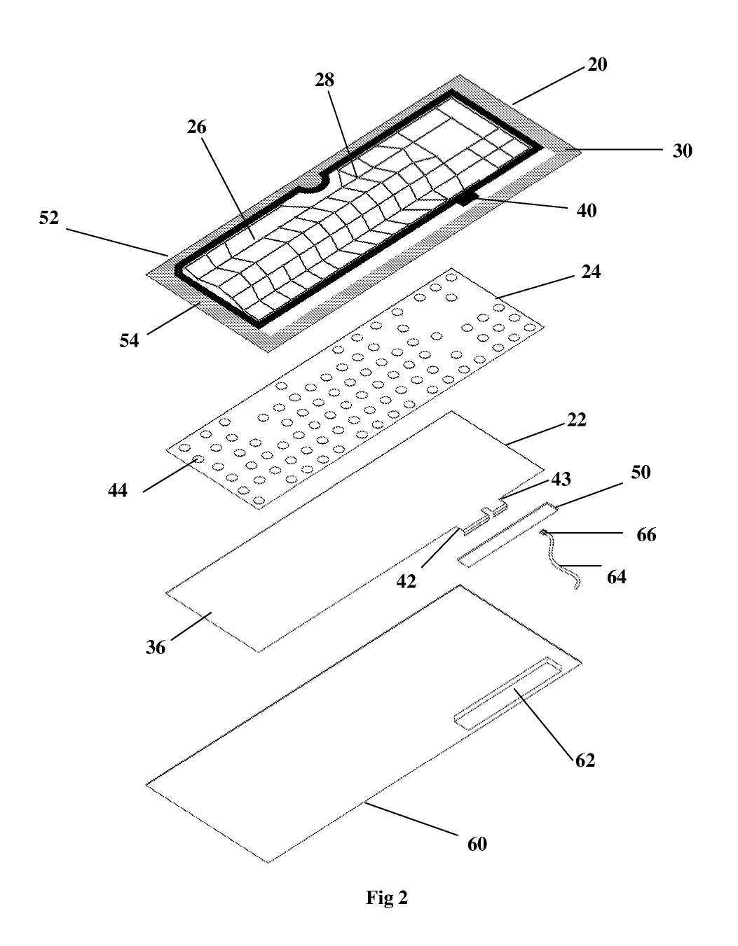

FIG. 2 shows an exploded view from below of the input assembly of FIG. 1;

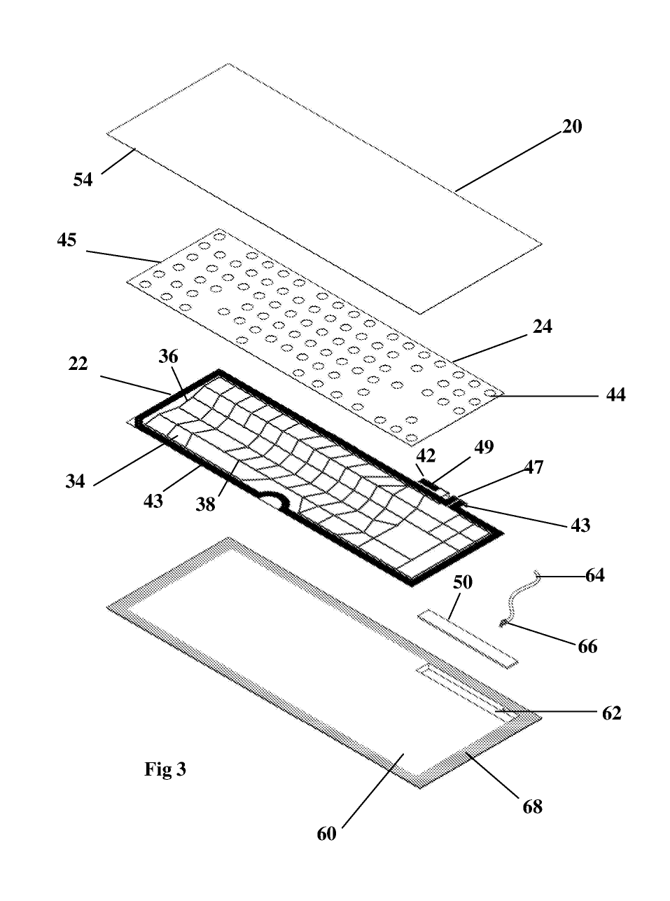

FIG. 3 shown an exploded view from above of the input assembly of FIG. 1;

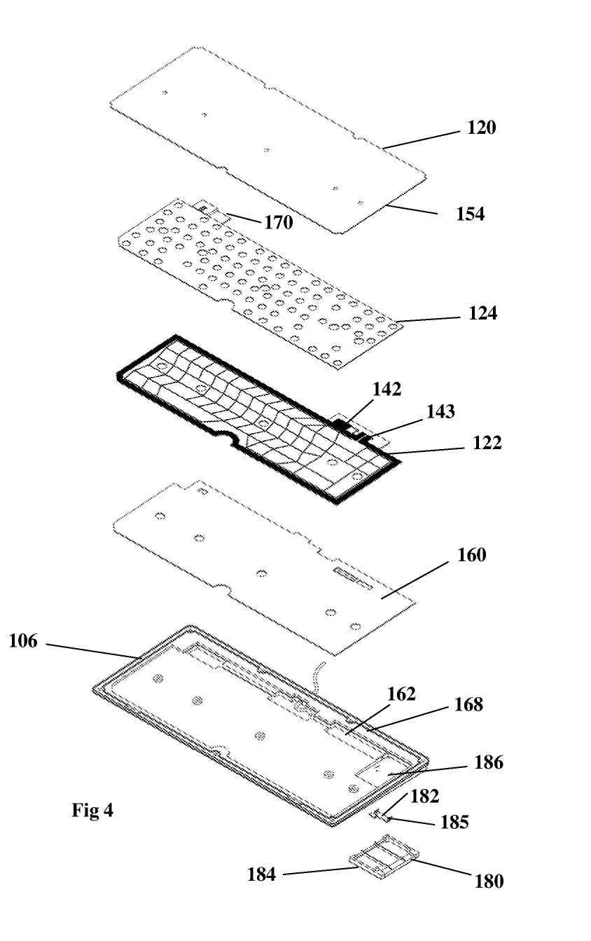

FIG. 4 is an exploded view from above of an input assembly comprising an electroluminescent spacer membrane, according to another embodiment of the invention;

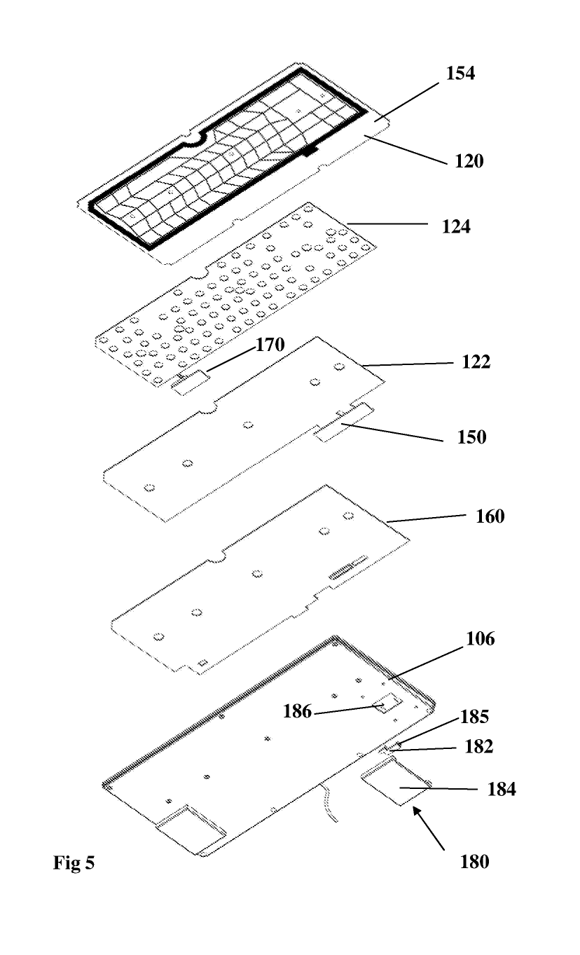

FIG. 5 shows an exploded view from below of the input assembly of FIG. 4;

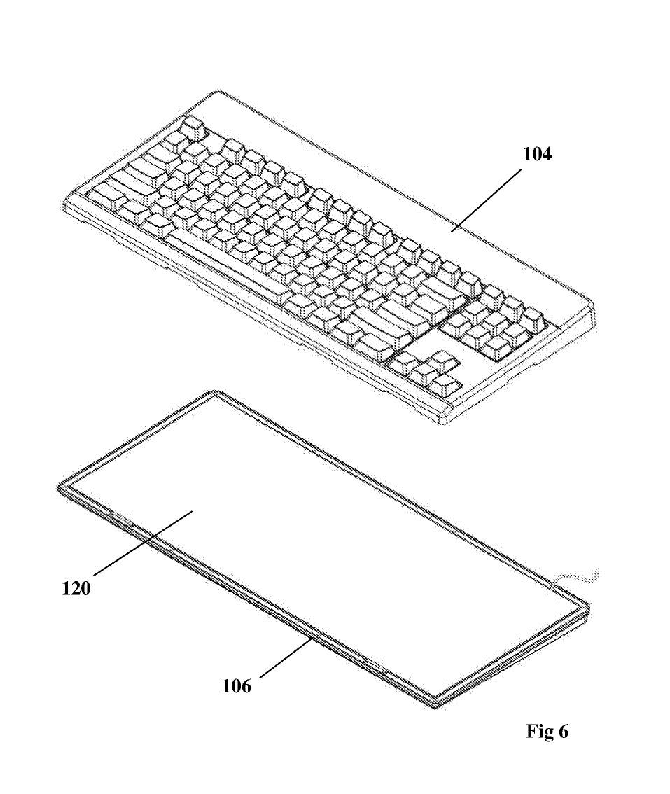

FIG. 6 is an exploded view from above of a keyboard assembly according to an embodiment of the invention including the keytop and having the input assembly sealed to the base;

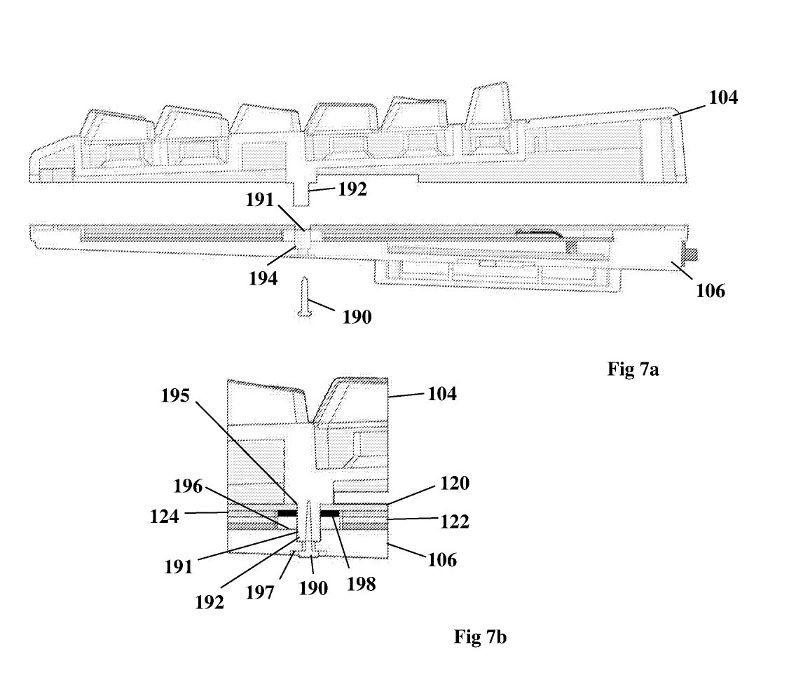

FIG. 7a shows a side section view of a keyboard assembly according to an embodiment of the invention; and

FIG. 7b is an enlarged view of the connection point of the arrangement of FIG. 7a.

Referring to FIG. 1, a computer keyboard 1 comprises an outer casing 2 including a keytop 4 and a base 6. Both the keytop 4 and base 6 are formed from moulded plastic such, and preferably formed from a moulded polymeric material. The keytop 4 and base 6 include corresponding and opposing peripheral connection sections 4a and 6a which enable the two components to be connected together to form the outer casing 2.

The keytop 4 movably supports keypad 10 including multiple keys 12 arranged in a key matrix. An input assembly 8 is arranged beneath the keypad 10 for converting a mechanical input applied to the keypad 10 to an electrical input to a printed circuit board (PCB) to generate a command signal to be passed to a computer or similar device. The input assembly 8 comprises a grid of circuits arranged such that the circuits are broken at discrete points beneath each key. A processor monitors the key matrix for signs of continuity at any point on the grid. When it finds a circuit that is closed, it compares the location of that circuit on the key matrix to a character map in its ROM to determine the character to which the specific key corresponds.

The keypad 10 may include a plurality of rubber domes (not shown) located beneath each key 12. The rubber domes are arranged such that when the corresponding key 12 is pressed, a plunger in the bottom of the key 12 pushes down against the dome. This causes the rubber dome to push down also, until it presses against the input assembly 8 beneath the keypad 10. As long as the key 12 is held, a circuit on the input assembly 8 is completed at a discrete point corresponding in the character map to the specific key 12 depressed. When the key is released, the rubber dome springs back to its original shape, forcing the key back up to its rest position. Other key mechanism such as scissor mechanisms or buckling spring mechanisms may alternatively be utilized.

As shown in FIG. 2, the input assembly 8 comprises an upper membrane 20, a lower membrane 22, and a spacer membrane 24 arranged between the upper membrane 20 and the lower membrane 22. The upper membrane is formed from a flexible, non-conductive material such as polyethylene terephthalate (PET), and preferably a boPET such as Mylar®. A circuit 26 is provided on the lower surface of the upper membrane 20. The circuit may be provided on the lower surface 30 by means of printing using an electrically conductive ink, or any other suitable means. The circuit 28 comprises a plurality of nodes corresponding to the key matrix of the keypad 12.

The lower membrane 22 is formed from the same material as the upper membrane 20. As shown in FIG. 3, the lower membrane 22 includes a circuit 34 on its upper surface 36 formed in the same manner as the circuit 26 of the upper membrane 20. The circuit 34 includes a plurality of nodes which positionally correspond to the nodes 28 of the upper membrane circuit 26. Both the upper membrane circuit 26 and lower membrane circuit also include output tracks 40 and 42 respectively for connection to a PCB 50.

The non-conductive spacer membrane 24 is positioned between the upper membrane 20 and the lower membrane 22, and is formed from the same material as the upper and lower membranes 20 and 22, although this is not essential and other non-conductive materials may be used. The spacer membrane 24 electrically isolates the upper circuit 26 from the lower circuit 34. A plurality of apertures 44 are formed in the spacer membrane 24 at locations corresponding to the nodes 28 and 38 of the upper and lower membrane 20 and 22. The size of the apertures 44 is selected such that nodes 28 and 38 of the upper circuit 26 and lower circuit 34 aligned with the apertures are held spaced apart. Specifically, the diameter of the apertures 44 is selected such that the depth of sag of the upper membrane 20 within the aperture 44 is less than the thickness of the spacer membrane 24. Preferably the thickness of each membrane is 100 micrometers, but the width of the apertures 26 may be varied for varying membranes thicknesses and hence varying sag coefficients.

The upper membrane 20, lower membrane 22 and spacer membrane are secured together to form the input membrane assembly 8. In three-membrane input assembly arrangements of the prior art, the three membranes are of equal size and are secured together and sealed around their periphery to form a watertight envelope. However, external components not contained within the input assembly, such as a PCB, which are connected externally to the input membrane assembly, remain vulnerable to exposure to liquids. Therefore, a further means of waterproofing these components is required, which may include for example providing a rubber sheet to cover both the input assembly and the external component, or encasing the component in a further water proof housing.

In the present invention, a means of ensuring both the input circuitry and the further electrical components required for the keyboard, such as the PCB, are sealed and waterproofed in a convenient and effective manner.

In a first embodiment of the invention, as shown in FIG. 2, the lower membrane 22 and spacer member 26 are of equal size, having an equal surface area and peripheral shape. The spacer member 24 is secured to the upper surface 34 of the lower membrane 22 by an adhesive applied at various point locations across the lower surface of the spacer membrane 24 selected to prevent interference with the printed circuit 34. The spacer membrane 24 and lower membrane 22 are similarly adhered to the lower surface 30 of the upper membrane 20 by a dotted adhesive. The lower membrane 22 may be sized such that its peripheral edge 43 extends past the peripheral edge 45 of the spacer member 24 to define a securing surface having adhesive applied thereto for adhering directly to the upper membrane 20.

To waterproof the input assembly and the further electrical componentry of the keyboard, the upper membrane 20 is formed to have a larger surface area, defining a large footprint than the lower membrane 22 and the spacer member 26. The peripheral edge 52 of the upper membrane 20 extends past the peripheral edges of the lower membrane 22 and spacer membrane 24 to form an overhanging fringe section, the lower surface of which defines a sealing surface 54 around the periphery of the upper membrane.

The sealing surface 54 is positioned outwardly of the circuit 26 of the upper membrane 20, and outwardly of the connection tracks 40. Similarly, when placed over the lower membrane 22, the sealing surface 54 is positioned outwardly of the circuit 34 of the lower membrane 22, and outwardly of the connection tracks 42 and 43. The connection tracks 40 of the upper membrane are positioned to overlay and connect with the corresponding further connection tracks 43 on the lower membrane 22. The lower membrane 22 is formed such that the connection tracks 42 and 43 are formed on 47 and 49 extending from the periphery of the lower membrane 22. The tabs 47 and 49 may be bent downwardly away from the upper membrane 20 to provide connection points for the PCB or other external components. The sealing surface 54 is also positioned such that it extends past and seals the PCB or other components when connected to the tabs 47 and 49.

In 3-membrane arrangements of the prior art, the upper membrane comprises a first tracked connection tab, and the lower membrane includes a second connection tab. The membranes are sealed such that both the upper and lower tabs remain externally accessible for connection to further components. By connecting downwards from the connection tracks 40 of the upper membrane 20 to the tracks 43 of the lower membrane 22, no connection tab is required for the upper membrane 20, with the tab instead extending from the lower membrane 22 only. Therefore, the connection tracks 40 of the upper membrane 20 do not need to extend to the periphery of the membrane 20 and as such can be located inboard of the sealing surface 54, allowing the sealing surface 54 to extend uninterrupted around the periphery of the upper membrane 20, and sealing the tracks 40 therewithin. The tracks 43 to which the tracks 40 are connected are also positioned inboard of the sealing surface 54 and connect downwardly to the PCB 50, rather than outwardly, with the PCB also being sealed within the periphery of the sealing surface 54.

A steel support plate 60 is provided to which defines a base to which the input membrane assembly is secured, the plate 60 being secured on its opposing surface to the base of the keyboard assembly. Alternatively, the input assembly may be secured directly to the base of the keyboard assembly, having a surface area and peripheral shape which are the same as the upper membrane 20. The support plate 60 provides rigidity to the input assembly 8, as well as to the finally assembled keyboard 1. In addition, the support plate 60 provides a surface for the upper membrane to adhere to, to seal and encapsulate the lower membrane 22 and spacer membrane 24. The support plate 60 includes a sealing portion 68 which aligns with and corresponds to the sealing surface 54. An adhesive is applied to the sealing surface 54 of the upper membrane 20 and/or to the sealing portion 68 of the support plate 60, and the upper membrane 20 is secured to the support plate 60 by the sealing surface 54 such that the lower membrane 22 and spacer membrane are sandwiched between the support plate 60 and the upper membrane 20, and sealed around their entire periphery by the sealing surface 54. As such, the upper membrane 20 functions as a sealing blanket which covers, seals and encapsulates the lower membrane 22 and spacer membrane 24 against the support plate 54 to form a watertight sealed lamination in which the electrical circuits 26 and 34 are sealed and protected from liquid damage.

The support plate 60 comprises a recessed receptacle 62 configured to receive the PCB 50, which may alternatively be formed in the base of the keyboard assembly to which plate 60 is secured. The recess 62 is formed such that when the PCB is received therein, the upper surface of the PCB lies level with or below the upper surface of the plate 60. This ensures that the membrane assembly is able to lie flush against the plate 60 without interruption from the PCB 50. The recess 62 is formed in the plate 60 inwardly of the peripheral edge and is positioned such that when the membrane assembly is secured to the base plate 60 the recess 62 is aligned with the tabs 42 and 43. The sealing surface 54 is configured such that it extends outwardly of the recess 62 to seal against the portion of the support plate 60 outboard of the recess 62. As such, when the PCB 50 is received in the recess 62 and the upper membrane 20 is secured to the support plate 60, the sealing surface seals and encapsulates the PCB 50 and the connections between the PCB 50 and the tabs 42 and 43, which are positioned within the sealing perimeter defined by the sealing surface.

An outlet port may be provided in the base or side wall of the recess 62 to allow a connecting cable 64 to exit the sealed membrane arrangement for connection to the processor or other component of a computer. The cable 64 is provided with a grommet plug 66 or similar sealing element to seal the cable outlet. As such, once assembled, the input assembly 8 is a sealed unit containing the keypad input matrix circuitry, the support plate 60, and the PCB 50, with a connection cable 64 sealed with and extending from the input assembly 8. The input assembly may therefore be placed into the shell 2 of a keyboard, comprising the keytop 4 and base 6, and provide a watertight keyboard arrangement without the keypad 12 or casing 2 themselves having to be watertight. In addition, no further sealing element is required over the input assembly 8. As such, assembly is simplified and merely requires the input assembly 8 to be located in the casing 2, and the keytop 4 and base 6 to be connected.

The process of assembling the input assembly comprises firstly forming the upper, lower and spacer membranes 20, 22 and 24 to the required peripheral shapes by die cutting or any other suitable forming means. The circuits 26 and 34 are then printed onto the upper and lower membranes 20 and 22 respectively, although printing may alternatively be undertaken prior to the die cutting of the membranes. The upper membrane 20, lower membrane 22 and spacer membrane 26 are then adhered together as described above. The adhesion of the membrane may be undertaken in any sequence. Once the three membranes 20, 22, and 26 have been adhered together, the PCB 50 may then be connected to the tabs 42 and 43. The lower membrane 22 is adhered to the other membranes such that the tabs 42 and 43 are freely accessible and within the boundary defined by the securing surface 54. The tabs 42 and 43 are preferably bent downwards, and are formed for connection to the connection point of the PCB 50 via a push fit or clamp connection.

The steel base 60 is cut to size to have a peripheral edge conforming to the peripheral edge of the upper membrane 20. The steel base 60 is press formed to create the recess 62 for receiving the PCB 50. An adhesive is applied to the sealing surface 54, and the PCB is located in the recess 62 such that is within the boundary of the sealing surface 54. The upper membrane 20 is then aligned with the base 60 and the sealing surface 54 is urged into contact with the base 60 to adhere the upper membrane 20 to the base 60 and form a complete seal around the entire periphery of the base 60. The seal between the upper membrane 20 and the base 60 seals and encapsulates the lower membrane 22, spacer membrane 24 and the PCB 60. In this way a sealed laminated unit is formed for onward connection into a keyboard casing.

For final assembly of the keyboard 1, the laminated input assembly 8 is adhered to the base 2. Adhesive is applied around the entire periphery of the base of the support plate 60 to secure and seal the plate 60 to the base 2. As such, components exposed or extending through the base of the support plate 60 are sealed between the peripheral edge of the support plate 60 and the base 2. In this way, components may be externally connected to the input assembly 8 upwards through the base 2, with the connections to the input assembly remaining watertight by sealing the surface of the component including the exposed electrical connections to the base 2, such as a memory card reader.

In an alternative arrangement shown in FIGS. 4 and 5, the keyboard base 106 is provided having an upper surface comprising a sealing surface 168 corresponding to the sealing surface 154 of the upper membrane 120. The base 106 is molded to include a recess 162 for receiving the PCB 150. Following adhesion of the upper, lower and spacer membranes 120, 122, and 124, and connection of the PCB 150 to the tabs 142 and 143, the PCB 150 is located in the recess 162. The sealing surface 154 is then adhered directly to the corresponding sealing surface 168 of the base 106, such that the upper membrane 120 forms a sealing blanket sealing and encapsulating the lower membrane 122, spacer membrane 124 and PCB 150.

A further steel support plate 160 may be provided between the lower membrane 122 and the base 102 to increase the stiffness of the base. The steel plate 160 is formed such that its peripheral edge is smaller than, and therefore lies inwards of the sealing surface 154. The steel plate may be formed to include the recess 162, or may be provided with a cut-away or apertures to allow the PC 150 to be received within the recess 162 formed in the base 102, or to allow through connection of the tabs 142 and 143 to the PCB 160 which may be positioned beneath the plate 160.

As shown in FIG. 6, when the upper blanket membrane 120 is sealed by its sealing surface 154 to the sealing surface 168 of the base, a sealed base unit 190 is formed. The upper membrane 120 and the outer region 169 of the base 106 surrounding the sealing surface 168 form a sealed substantially continuous planar surface 192. No recesses extend into the base 190 from above, such that water ingress past the planar surface 192 into the base 106 is prevent. In addition, the continuous planar surface prevents the liquid and debris from the keytop 102 from collecting, and the sealed base unit is easily and safely able to be submersed in water to clean any debris or liquid present on its surface. Cleaning of the base unit 190 is further facilitated by the releasable configuration of the keytop 102, which is releasably and removabley connected to the base unit 190.

The keytop 104 includes scalloped sections or recesses 109 formed along its lower edge. When the keytop 104 is secured to the base 106 the recesses 109 define drainage slots, for allowing liquid which has passed into the keyboard 101 through the keytop 104 to drain off the surface of the base unit 190. As the base unit 190 comprises a planar, hermetically sealed surface 192, water falling onto the surface 192 does not pass into the base 106 and instead runs off the surface 192 uninterrupted. The slots 109 allow the water to run off the surface 192 and drain out of the keytop 104, therefore allowing the keyboard to be washed without removing the keytop 104 if required.

The spacer member 124 is formed from an electroluminescent material, which illuminates when provided with an electric current. A driver 170 electrically connects to the spacer membrane 124. The driver 170 is connectable to an external power supply or may be provided with an internal power source. The driver 170 selectively supplies a current to the spacer membrane 124, the current being selected according to the size and thickness of the membrane 124 to cause illumination at a required luminosity. The driver 170 may be activated to illuminate the spacer membrane 124 in response to an input command from a dedicated switch, in response to an input signal from the PCB, or by any other suitable means.

The upper membrane 120 is formed from a transparent or at least partially light previous material. When the spacer member is illuminated, light passes through the upper membrane 120 to the underside of the keytop (not shown). Portions of the keytop and/or the keypad are configured to be transparent, or partially transparent, or to have light permitting voids, such that they become illuminated when the spacer membrane 124 is illuminated. This advantageously assists a user in key recognition in low light conditions and/or provides the keyboard with an aesthetically pleasing visual appearance.

Illuminated keyboards of the prior art provide a separate electroluminescent sheet, or electroluminescent tracking between the input assembly and the keypad. Not only does this require an additional component, thereby adding to the complexity and cost of the keyboard, but the electroluminescent sheet and its driver must be separately sealed and isolated if the keyboard is to be waterproofed. In the present arrangement, the electroluminescent spacer member 124 and the driver 70 are positioned within the boundary of the sealing surface 154. A recess is also provided in the keyboard base 106 or support plate 160 for receiving the driver 170. As such, the electroluminescent spacer membrane 124 and the driver 170 are sealed and encapsulated by the upper blanket membrane 120. By using the spacer member 124 as the electroluminescent sheet, the membrane 124 performs a dual function, thereby obviating the requirement for a separate electroluminescent sheet, simplifying assembly, reducing parts and saving cost. In addition, using the spacer member 124 as the electroluminescent sheet allows the electroluminescent sheet and its driver to be sealed by the upper blanket membrane 120, and as such additional sealing elements are not required, again reducing complexity and cost.

The keyboard base 106 may be provided with a memory card reader 180, as shown in FIGS. 4 and 5. The card reader 180 includes an electrical connection terminal 182 and a housing 184 defining a card receiving slot which is open at opposing ends to enable the slot to be washed through. The terminal 182 includes connection pins 185 which are received within pin holes 186 in the base 106. The base 106 also includes a recess for receiving the body of the terminal 182. The pins 185 are extended through the pin holes 186 and adhesion of the body 182 to the base 106 seals the connection pins within the base 160 in a watertight fashion, with no water being able to reach the pins internally due to the seal between the plate 60 and the base 106.

The keytop 104 and base 106 may be connected by any suitable connection means such as screws, latches, clips or other fixings. As such, the keytop 104 is readily and easily removable from the base 106. As the electronics of the keyboard are provide and sealed within the base 190 beneath the blanket membrane 120, the keytop itself becomes a cheap and easily interchangeable component of the keyboard.

In the arrangement shown in FIGS. 7a and 7b, the keytop 104 is connected to the base 106 by screws 190. A plurality of spigots 192 corresponding to the screws 190 extend downwardly from the keytop 104. Corresponding recesses 194 are formed in the base 106 for receiving the spigots 192, which includes a channel 191 open to the lower surface of the base 106 for receiving the threaded shaft of screw 190, but not wide enough to receive the screw head; further recesses 197 are provided in the lower surface of the base 106 as a countersink for the screw heads. The spigots 192 include a threaded central bore, and to connect the keytop 104 and base 106, the screws 190 are inserted through the lower surface of the base 106 into the recesses 194 where they are threadingly received by the central bores of the spigots 192. The screws 190 pull the keytop 104 downwards into tight engagement with the base 106.

A raised lug 196 extends upwardly from the base 106 and surrounds and defines a portion of the channel. An aperture is formed through the spacer 124 and lower 122 membranes to accommodate the lug 196. The upper membrane 120 sits on top of the lug 196 and is sandwiched between the lug 196 and the keytop 103. The upper membrane comprises an aperture 195 of equal diameter to the channel 191, and configured to surround the spigot 195. A layer of adhesive 198 is provided on the lower surface of the upper membrane 120 in the area surrounding the aperture 195, to seal the upper membrane 120 to the lug 196. The area of the upper membrane 120 to which the adhesive layer 198 is applied is a continuation of the sealing layer 154, and prevents liquid from entering the input assembly via the aperture 195. As such, an effective and secure connection of the keytop 104 and the base 106 may be made while maintaining the watertight integrity of the input assembly 108 and the base 106.

In a further alternative arrangement, the spacer membrane may define the blanket membrane. In this arrangement, the spacer membrane is formed having a peripheral edge which extends past the peripheral edge of the lower membrane to define the sealing surface. The upper membrane is adhered around its entire periphery to the spacer membrane such that the printed circuitry on the lower surface is sealed against the spacer membrane. The lower member is also adhered to the spacer membrane. The sealing surface defined by the spacer membrane is adhered to the further surface, which may be the support plate or keyboard base, to seal and encapsulate the lower membrane and any components or connections connected thereto and contained within the sealing surface.

In a yet further alternative arrangement only a portion of the peripheral edge of the upper membrane 20 extends past the peripheral edges of the lower membrane 22 and spacer membrane 24 to define the sealing surface. The upper membrane 20 and lower membrane 22 are sealed around a significant portion of their peripheries, and share a common peripheral size and shape. A portion of peripheral edge of the lower membrane 22 extends inwardly of a portion of the peripheral edge of upper membrane 20 at the point at which the connection tracks 42 are provided. As such, the point at which the tracks 42 extend to edge of the peripheral portion of the lower membrane 22 defining the tabs 47 and 49 is inboard of the corresponding peripheral portion of the upper membrane 20. At this point the lower membrane 22 defines a cut away and the upper membrane forms and overhanging portion bridging and covering the cutaway portion and defining the sealing surface 54.

The majority of the input assembly is adhered to the base 2 or support plate 60 by an adhesive section applied around the periphery of the lower surface of the lower membrane 22. At the point where the periphery of the lower membrane 22 is interrupted by the cutaway portion, the sealing surface 54 adheres directly to the base 2 or support plate 60. In this way, the tracks 42 and other connections located within the cutaway are sealed against the base 2 or plate 60 by the sealing surface 54, which completes the seal joining the remaining peripheral edge of the upper membrane 20 to the corresponding peripheral edge of the lower membrane 22.

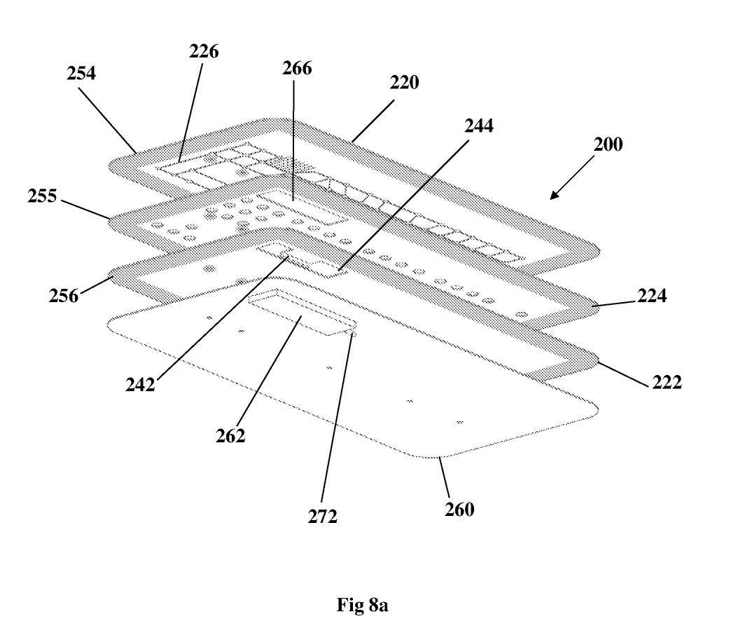

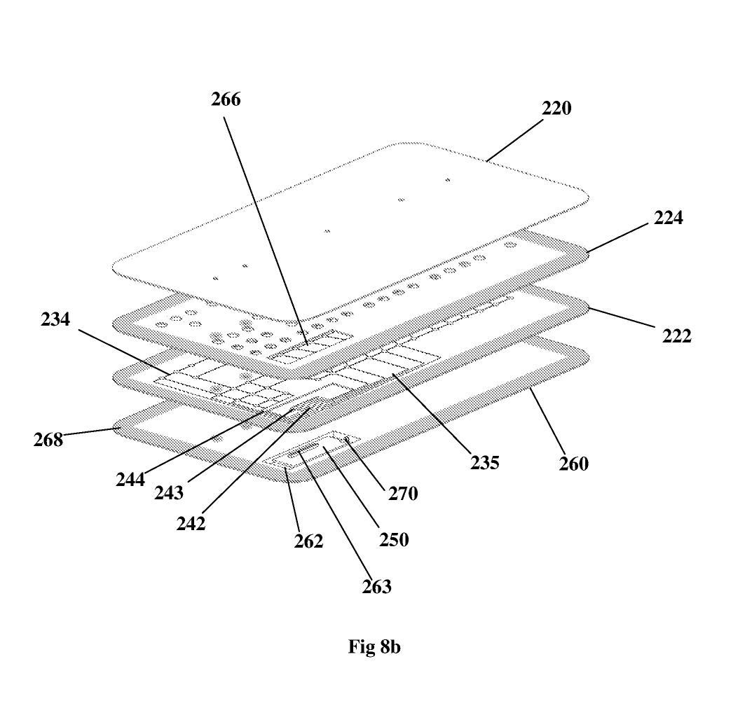

In a further embodiment shown in FIGS. 8a and 8b, a membrane assembly 200 is formed from an upper membrane 220, a lower membrane 222 and a spacer membrane 224. Each of the membranes is of a similar size. The sealing surface 254 of the upper membrane adheres the upper membrane to the spacer membrane 224. Similarly, the sealing surface 255 of the spacer membrane 224 secures the spacer membrane 224 to the lower membrane 222. In this way a sealed membrane assembly 200 is formed in which the circuits of the upper and lower membranes 220,222 are sealed.

The printed circuit 234 of the lower membrane 222 forms a circuit pattern on the lower membrane 222 having a circuit periphery 235. The circuit 234 includes a connection track 242 for connecting the circuit to a further component such as a PCB. As can be seen from FIG. 8b, the circuit 234 is formed such that the connection track 242 extends inwardly of the circuit periphery 235, in contrast to arrangements of the prior art in which it is essential that the tracks extend outwardly of the circuitry and the membrane assembly for connection to further external components. Similarly, when the membrane assemblies of the prior art are secured to a keyboard base, the further components must be housed and sealed outside the periphery of the membrane assembly, adding complexity and requiring additional space within the keyboard housing.

The inwardly extending connection tracks 242 define a connection member having an end defining a connection portion 243 for connection to a further component, such as a PCB 250. The PCB 250 includes a connection slot 263 configured to receive the connection portion 243. The connection portion 243 extends downwardly in a direction perpendicular to the horizontal plane defined by the membrane assembly 200. To facilitate this downward orientation, the lower membrane 222 is stamp cut to form free ended tab coincident with the tracks 242, the free end supporting and further defining the connection portion, and being bendable downwardly. Preferably the lower membrane 222 is stamp cut such that a window 244 surrounds the connector portion 243, and permits improved access to the connection portion 243 when inserting it into the connection slot 263 of the PCB 250. The spacer membrane 224 includes a window 266 to further improve access for connection of the connection portion 243 to the PCB 250. The window is positioned such that it is aligned with the track 242, and such that when the spacer membrane 224 is secured to the lower membrane 222, an assembly worker may reach through the window to access the connection portion 243 for insertion into the slot 263 of the PCB 250.

The PCB 250 is housed in a recess 262 formed in the support member 260, which defines a sunken receptacle or ‘coffin’ for receiving the PCB 250 such that it lies flush with or beneath the upper surface of the support member 260. The support member 260 may be a support plate for connection to the base of the keyboard housing, or may be the base of a keyboard housing itself.

The membrane assembly is arranged such that the sealing surface 254 secures the upper membrane 220 to the spacer membrane 224, and the sealing surface 255 secures the spacer membrane 224 to the lower membrane 222. The sealing surface 256 of the lower surface of the lower membrane 222 defines the sealing surface form securing the membrane assembly to the support member 260. The sealing surface 256 defines a sealing periphery which extends about the entire peripheral edge portion of the membrane assembly 200. The track 242 and in particular the connection portion 243 I located within the sealing periphery 256. The recess 262 is also positioned such that it is located within the sealing periphery when the membrane assembly is secured to the support member 260. As such, when the membrane assembly is secured to the support member 260 it seals and encapsulates the circuitry of the upper and lower membranes 220, and 222, the connection track 242, including the connection portion 243, and the PCB 250. In this way, all of the electrical circuitry and components of the keyboard input assembly are sealed and contained in a single sealed unit by a single sealing means. A keytop may then be located over the input assembly, and may be washed when so connected without risk of damage to the input assembly.

The recess 262 includes an outlet port 272 for permitting external electrical connection to the PCB 250, or other component contained therein. The port 272 includes and aperture for permitting a cable to pass into the recess 262, and sealing means for sealing the aperture to prevent liquid ingress into the recess 262. The support member 260 may include further recesses formed in a similar manner to the recess 262 for receiving additional components such as contact or contactless card reading means, drivers for electroluminescence, and any other electrical componentry which may be conceivably used and housed within the keyboard assembly. In addition, the support member may include a recessed channel or channels for receiving cabling to connect the component received within the additional recesses. Each of the additional recesses and channels are positioned and arranged such that they are within the sealing periphery and are sealed and enclosed within the sealed unit defined by the membrane assembly 200 and the support member 260.

It will be appreciated that in further embodiments various modifications to the specific arrangements described above and shown in the drawings may be made. For example, it is noted that the terms upper and lower are used to describe the arrangement of the membrane layers relative to a further surface, with upper meaning uppermost or furthest spaced from the further surface. These terms are not intended to be limiting and do not refer to any specific orientation, and for example in use the upper layer may be positioned below the lower in terms of the absolute vertical positions of the membranes, while still being above the lower layer in terms of the further layer to which they are secured. Similarly the terms upper layer and lower surfaces refer to the direction in which the surfaces face relative to the further layer, with the upper surface facing away from the further surface. Furthermore, while the input assembly is described for use with a computer keyboard, it could be used in connection with any device requiring conversion of a manual point input from a user to a corresponding electrical signal, for example in the control pad of an ATM machine, or other external interfaces requiring user input. In addition, it will be appreciated that the electroluminescent spacer membrane may be provided in any of the arrangements described above. Similarly, it will be appreciated that arrangement described above including the electroluminescent may alternatively be provided with a conventional spacer member as in the first described embodiment. It will also be appreciated that the support member may be any further surface to which the membrane assembly is secured, and includes but is not limited to planar members. For example it is conceived that the membrane assembly could conform and be sealed to uneven or ergonomically shaped surfaces.

1. An input assembly for a human interface device comprising:
a membrane assembly including a first membrane having an electrical circuit provided on a surface thereof, a second membrane having electrical circuit provided on a surface thereof, the first and second membranes being arranged such that the electrical circuits of each membrane are facing each other, and means for permitting selective electrical connection between the electrical circuits of the first and second membranes;
an electrical connector connected to the electrical circuit of one or both of the first or second membranes and comprising a connection portion configured for connection to a further electrical component; and
sealing means configured to seal the membrane assembly to a further surface to form a sealed unit which seals and encapsulates both the electrical circuits of the membrane assembly and the connection portion of the electrical connector.

2. The input assembly according to claim 1 wherein the sealing means defines a sealing perimeter and the connection portion of the electrical connector is arranged such that it is located within the sealing perimeter to be sealed and encapsulated by the sealing means when the sealing means is sealed to the further surface.

3. The input assembly according to claim 2 further comprising a support member defining the further surface, wherein the support member comprises a recess configured to receive the further electrical component connected to the electrical connector, the recess being arranged such that when the membrane assembly is sealed to the support member the recess is located within the sealing perimeter such that the sealing means seals the recess and any further electrical component contained therein.

4. The input assembly according to claim 3 wherein the recess is configured and arranged such that when the further electrical component connected to the electrical connector is received within the recess the membrane assembly is able to lie substantially flush with the surface of support member and seal thereto.

5. The input assembly according to claim 3 wherein the recess comprises a port configured to receive an additional electrical connector for connecting to the further electrical component.

6. The input assembly according to claim 5 wherein the recess is defined in the upper surface of the support member, and the port extends through the support member to the lower surface thereof to permit connection to external components, the port comprising a seal to prevent liquid egress into the recess.

7. The input assembly according to claim 3 wherein the support member comprises one or more additional recesses configured to receive electrical components, each of the recesses being arranged such that when the membrane assembly is secured to the support member the recess is located within the sealing perimeter to be sealed by the sealing means.

8. The input assembly according to claim 3 wherein the assembly membrane and the support member form a sealed unit, with the electrical circuits and further electrical component being contained and sealed therein.

9. The input assembly according to claim 1 wherein the electrical connector is a conductive track formed as part the printed electrical circuit of the first or second membrane, and the connection portion is located inboard of the peripheral edge of the membrane to which the connector corresponds.

10. The input assembly of claim 9 wherein the electrical connector is configured such that the connection portion is orientable downwardly relative the membrane to which it is connected for connection to the further electrical component.

11. The input assembly of claim 9 wherein the second membrane is a lower membrane configured to be located between the first membrane and the further surface when the membrane assembly is sealed thereto, and the electrical connector is an integral part of the electrical circuit of the second membrane.

12. The input assembly according to claim 11 further comprising a spacer member provided between the first and second membranes which defines the means configured to permit selective electrical connection between the electrical circuits of the first and second membranes.

13. The input assembly of claim 12 wherein the spacer member comprises a window formed therein which is arranged to correspond to the location of the electrical connector such that it is alignable over the electrical connector when the spacer membrane is secured to the second membrane to permit access thereto during assembly.

14. The input assembly of claim 1 wherein the sealing means comprises a surface of the membrane assembly which defines a sealing surface and is adhered to the further surface.

15. The input assembly according to claim 14 wherein at least part of the peripheral edge of the first membrane or spacer member extends past at least part of the peripheral edge of the second membrane to define the sealing surface.

16. The input assembly according to claim 14 wherein the sealing surface extends around the entire periphery of the first membrane or spacer membrane.

17. The input assembly according to claim 12 wherein at least a portion of the first membrane defines the sealing surface and at least part of the peripheral edge of the first membrane extends past the peripheral edge of the spacer member and second membrane to seal the lower membrane and the spacer member between the first surface and the further surface.

18. A method of forming an input assembly for a human interface device comprising:
providing a membrane assembly including a first membrane having an electrical circuit provided on a surface thereof, a second membrane having electrical circuit provided on a surface thereof, the first and second membranes being arranged such that the electrical circuits of each membrane are facing each other, and means for permitting selective electrical connection between the electrical circuits of the first and second membranes;
connecting a connection portion of an electrical connector connected to the electrical circuit of one or both of the first or second membranes and comprising configured to a further electrical component; and
sealing the membrane assembly to the further surface such that the means for sealing means defines a sealing perimeter which surrounds and seals both the connection portion of the electrical connector and the further electrical component to which it is connected.

19. The method of claim 14 further comprising locating the further electrical component in a recess in a support member defining the further surface prior to sealing the membrane assembly to the further surface, such that the membrane assembly seals the component within the recess when sealed to the further surface.

20. A keyboard assembly comprising:
an input assembly according to claim 1, and
a key pad including a plurality of keys in operable communication with the electrical circuits of the membrane assembly.

21. An input assembly for a human interface device comprising:
a first membrane having an electrical circuit provided on a surface thereof;
a second membrane having electrical circuit provided on a surface thereof, the first and second membranes being arranged such that the electrical circuits of each membrane are facing each other; and
a spacer member provided between the first and second membranes configured to permit selective electrical connection between the electrical circuits of the first and second membranes;
wherein at least a portion of the first membrane or at least a portion of the spacer member defines a sealing surface for sealing at least a portion of the lower membrane between the first membrane or spacer member and a further surface.

22. The input assembly according to claim 21, wherein at least part of the peripheral edge of the first membrane or spacer member extends past at least part of the peripheral edge of the second membrane to define the sealing surface.

23. The input assembly according to claim 22 wherein the sealing surface extends around the entire periphery of the first membrane or spacer membrane.

24. The input assembly according to claim 21 wherein at least a portion of the first membrane defines the sealing surface and at least part of the peripheral edge of the first membrane extends past the peripheral edge of the spacer member and second membrane to seal the lower membrane and the spacer member between the first surface and a further surface.

25. The input assembly according to claim 21 wherein at least a portion of the spacer member defines the sealing surface and at least part of the peripheral edge of the spacer member extends past the peripheral edge of the second membrane to seal the lower membrane between the spacer member and a further surface.

26. The input assembly according to claim 21 wherein the second membrane comprises a first electrical connector for connection to a further electrical component and the sealing surface is arranged outwardly of the connector such that the connector is sealed when the sealing surface is sealed to the further surface.

27. The input assembly according to claim 26 wherein the second membrane comprises a second electrical connector for connection to a further electrical component, the second electrical connector being electrically connected to the electrical circuit of the upper membrane, the upper membrane being configured such that the sealing surface is located outwards of the second connector to seal the second connector when the sealing surface is sealed to the further surface.

28. The input assembly according to claim 27 wherein the lower membrane comprises a pair of tabs extending from its peripheral edge, the tabs being provided with the electrical connector and second electrical connector and located inwards of the sealing surface.

29. The input assembly according to claim 21, further comprising a support member defining the further surface, wherein the support member is arranged on the opposing side of the second membrane to the spacer member and wherein the sealing surface is secured to the support member to encapsulate and seal the second membrane.

30. The input assembly according to claim 29 wherein the support member is a rigid support plate.

31. The input assembly according to claim 29 wherein the peripheral edge of the support member corresponds in shape to the peripheral edge of the first membrane such that the peripheral edges align when the sealing surface is sealed to the support member to form a laminate assembly sealed around its periphery.

32. The input assembly according to claim 29 wherein the support member comprises a sealing portion configured to align with and seal against the sealing surface and a receiving section for receiving a further component, the receiving section being located inwards of the sealing portion such that the receiving section is sealed beneath the first membrane when the sealing surface and sealing portion are sealed together.

33. The input assembly according to claim 21 wherein the spacer membrane is formed from an electroluminescent material, the input assembly further comprising electrical supply means configured for supplying an electrical current to the spacer membrane.

34. A method of forming an input assembly for a human interface device comprising:
providing a first membrane having an electrical circuit provided on a surface thereof;
providing a second membrane having electrical circuit provided on a surface thereof;
arranging the first and second membranes such that the electrical circuits of each membrane are facing each other;
providing a spacer member between the first and second membranes configured to permit selective electrical connection between the electrical circuits of the first and second membranes; and
securing a sealing surface defined by at least a portion of the first membrane or at least a portion of the spacer member to a further surface to seal at least a portion of the lower membrane between the first surface or spacer member and the further surface.

35. An input assembly for a human interface device comprising:
a first membrane having an electrical circuit provided on a surface thereof;
a second membrane having electrical circuit provided on a surface thereof, the first and second membranes being arranged such that the electrical circuits of each membrane are facing each other; and
a spacer member provided between the first and second membranes configured to permit selective electrical connection between the electrical circuits of the first and second membranes;
wherein at least a portion of the spacer membrane is formed from an electroluminescent material.

36. The input assembly according to claim 35 further comprising electrical supply means configured for supplying an electrical current to the spacer membrane.
